(19) United States
(12) Patent Application Publication
(10) Pub. No.: US 2022/0389631 A1
(43) Pub. Date: Dec. 8, 2022

(54) FIBER MOLDED BODY FOR SOUND ABSORBING/SOUND INSULATION MATERIALS

(71) Applicant: Mitsubishi Chemical Corporation, Tokyo (JP)

(72) Inventors: Masaki FUJIE, Tokyo (JP); Tatsuhiko INAGAKI, Tokyo (JP)

(73) Assignee: Mitsubishi Chemical Corporation, Tokyo (JP)

(21) Appl. No.: 17/890,426

(22) Filed: Aug. 18, 2022

Related U.S. Application Data
(63) Continuation of application No. PCT/JP2021/007849, filed on Mar. 2, 2021.

(30) Foreign Application Priority Data
Mar. 2, 2020 (JP) 2020-034779

(51) Int. Cl. D04H 1/4382; D04H 1/541; D01F 6/18; D04H 1/4282; D01F 11/00; D04H 1/4326; G10K 11/162

(52) U.S. Cl. CPC D04H 1/43835; D04H 1/5418; D01F 6/18; D04H 1/4282; D01F 11/00; D04H 1/4326; G10K 11/162; D10B 2401/00; D10B 2505/12; B60R 13/08

(57) ABSTRACT

There is provided a fiber molded body for sound absorbing/sound insulation materials, which is lightweight and has excellent sound absorption performance. The fiber molded body for sound absorbing/sound insulation materials of the present invention is a fiber molded body for sound absorbing/sound insulation materials comprising uncolored ultrafine chemical fibers and colored fibers or reclaimed fibers, wherein the single fiber fineness of the ultrafine chemical fibers is 0.01 to 0.5 dtex, the content of the ultrafine chemical fibers is 5 to 70 mass % and the content of the colored fibers or the reclaimed fibers is 20 to 60 mass %, in the fiber molded body for sound absorbing/sound insulation materials.

### TECHNICAL FIELD

The present invention relates to a fiber molded body for sound absorbing/sound insulation materials.

This application is a continuation application of International Application No. PCT/JP2021/007849, filed on Mar. 2, 2021, which claims the benefit of priority of the prior Japanese Patent Application No. 2020-034779, filed Mar. 2, 2020, the content of which is incorporated herein by reference.

### BACKGROUND ART

It is required to have a function of reducing various noises in a wide range of fields from vehicle parts used for railway vehicles, vehicles and the like, and interior or exterior materials of houses and the like to electrical products such as vacuum cleaners.

For example, noise that is introduced into a cabin of a vehicle is divided into noise that is introduced when a sound generated from an engine passes through a vehicle body and noise that is introduced when noise generated when tires come into contact with a road surface passes through the vehicle body.

As a method for reducing such noise, there is a method using a sound insulation material that insulates against inflowing noise, a sound absorbing material that absorbs inflowing noise, or a sound absorbing/sound insulation material having both sound absorption performance and sound insulation performance (hereinafter referred to as sound absorption/sound insulation performance).

Sound insulation means that the generated acoustic energy is reflected and blocked by a shield, and sound absorption means that the generated acoustic energy is converted into thermal energy while being transmitted along the internal path of the material, and disappears.

Improving sound absorption/sound insulation performance generally involves increasing the weight of the sound absorbing/sound insulation material, but recently, particularly in the field of vehicles, the need for improvement of fuel efficiency and resource saving has rapidly increased, and reducing the weight of sound absorbing/sound insulation materials has been strongly demanded.

In order to solve the issues of sound absorption/sound insulation performance and weight reduction, which are at odds, a material having excellent sound insulation for transmitted sound and efficient sound absorption of noise inflowing from other transmission paths (windows, etc.), in other words, a material having excellent balance of sound absorbing/sound insulation, is required.

In addition, in recent years, environmental problems have become more serious, and it is required to contribute to the circular economy using reclaimed fibers.

For example, in a vehicle, the transmitted sound from a dash compartment of an engine sound, which accounts for 50% or more of in-vehicle noise, mainly has a frequency of about 100 to 1,000 Hz, and it is required to efficiently perform absorption/insulation of sound in this region.

To achieve this object, for example, Patent Literature 1 proposes molding synthetic short fibers into a mat shape to form a sound absorbing material. Synthetic fibers of 1 to 50 deniers are used in place of commonly used glass fibers, but they are compressed to increase the mass in order to exhibit a sound absorption effect.

Patent Literature 2 proposes a lightweight soundproof material made of synthetic fibers including polyester fibers having a single fiber fineness of 0.6 dtex.

Patent Literature 3 provides a sound absorbing sheet in which glass fibers and cellulose fibers are combined, and describes that, by adjusting an air permeability and a porosity of a base material, the effect of sound absorption performance is exhibited even when the sound absorbing sheet is thin.

Patent Literature 4 proposes an inexpensive felt material using reclaimed fibers, but the sound absorption/sound insulation performance is not considered sufficient.

Patent Literature 5 proposes a non-woven fabric in which microfibers having a fiber diameter of 0.2 to 10 μm and a fiber length at which they pass through a sieve with a nominal opening of 11.2 mm are mixed with reclaimed fibers. However, as a result of insufficient entanglement of fibers in the non-woven fabric, the air permeability is low, and it is difficult to exhibit sufficient acoustic performance.

### CITATION LIST

### Patent Literature Patent Literature 1

Japanese Unexamined Patent Application, First Publication No. 2002-242066 Patent Literature 2

Japanese Unexamined Patent Application, First Publication No. 2016-034828 Patent Literature 3

Published Japanese Translation No. 2014-521995 of the PCT International Publication Patent Literature 4

Japanese Unexamined Patent Application, First Publication No. 2001-316963 Patent Literature 5

Japanese Unexamined Patent Application, First Publication No. 2009-287143

### SUMMARY OF INVENTION

### Technical Problem

An object of the present invention is to provide a fiber molded body for sound absorbing/sound insulation materials, which is lightweight and has excellent sound absorption performance.

### Solution to Problem

The present invention includes the following aspects. [1] A fiber molded body for sound absorbing/sound insulation materials comprising uncolored ultrafine chemical fibers and colored fibers,

wherein the single fiber fineness of the ultrafine chemical fibers is 0.01 to 0.5 dtex, and

wherein the content of the ultrafine chemical fibers in the fiber molded body for sound absorbing/sound insulation materials is 5 to 70 mass %, and the content of the colored fibers in the fiber molded body for sound absorbing/sound insulation materials is 20 to 60 mass %, or

a fiber molded body for sound absorbing/sound insulation materials comprising uncolored ultrafine chemical fibers and reclaimed fibers,

wherein the single fiber fineness of the ultrafine chemical fibers is 0.01 to 0.5 dtex, and

wherein the content of the ultrafine chemical fibers in the fiber molded body for sound absorbing/sound insulation materials is 5 to 70 mass %, and the content of the reclaimed fibers in the fiber molded body for sound absorbing/sound insulation materials is 20 to 60 mass %. [2] The fiber molded body for sound absorbing/sound insulation materials according to [1],

wherein the colored fibers are reclaimed fibers. [3] The fiber molded body for sound absorbing/sound insulation materials according to [1] or [2],

wherein the colored fibers and the reclaimed fibers are composed of chemical fibers and natural fibers, and the ratio between the chemical fibers and the natural fibers (chemical fibers (mass %):natural fibers (mass %)) is 40:60 to 95:5. [4] The fiber molded body for sound absorbing/sound insulation materials according to any one of [1] to [3],

wherein the content of the natural fibers in the fiber molded body for sound absorbing/sound insulation materials is 35 mass % or less. [5] The fiber molded body for sound absorbing/sound insulation materials according to any one of [1] to [4], further containing uncolored chemical fibers having a single fiber fineness of 5 dtex or more,

wherein the content of the uncolored chemical fibers having a single fiber fineness of 5 dtex or more in the fiber molded body for sound absorbing/sound insulation materials is 5 to 30 mass %. [6] The fiber molded body for sound absorbing/sound insulation materials according to any one of [1] to [5],

wherein the fiber length of the ultrafine chemical fibers is 12 to 60 mm. [7] The fiber molded body for sound absorbing/sound insulation materials according to any one of [1] to [6],

wherein the density is 10 to 70 kg/m³. [8] The fiber molded body for sound absorbing/sound insulation materials according to any one of [1] to [7],

wherein the basis weight is 1,000 to 2,500 g/m², and the sound absorption coefficient at a frequency of 1,000 Hz is 0.5 or more. [9] The fiber molded body for sound absorbing/sound insulation materials according to [8],

wherein the sound absorption coefficient at a frequency of 800 Hz is 0.4 or more. [10] The fiber molded body for sound absorbing/sound insulation materials according to [8] or [9],

wherein the sound absorption coefficient at a frequency of 500 Hz is 0.25 or more. [11] The fiber molded body for sound absorbing/sound insulation materials according to any one of [8] to [10],

wherein the thickness is 10 to 40 mm. [12] The fiber molded body for sound absorbing/sound insulation materials according to any one of [1] to [7],

wherein the basis weight is 100 g/m² or more and less than 1,000 g/m², and the sound absorption coefficient at 1,000 Hz is 0.35 or more. [13] The fiber molded body for sound absorbing/sound insulation materials according to [12],

wherein the sound absorption coefficient at 800 Hz is 0.25 or more. [14] The fiber molded body for sound absorbing/sound insulation materials according to [12] or [13],

wherein the sound absorption coefficient at 500 Hz is 0.20 or more. [15] The fiber molded body for sound absorbing/sound insulation materials according to any one of [12] to [14],

wherein the thickness is 5 to 30 mm.

### Advantageous Effects of Invention

According to the present invention, it is possible to provide a fiber molded body for sound absorbing/sound insulation materials which is lightweight and has excellent sound absorption performance.

### DESCRIPTION OF EMBODIMENTS

In this specification, “to” indicating a numerical range means that numerical values stated before and after “to” are included as a lower limit value and an upper limit value.

A fiber molded body for sound absorbing/sound insulation materials of the present invention contains uncolored ultrafine chemical fibers and colored fibers, the single fiber fineness of the uncolored ultrafine chemical fibers is 0.01 to 0.5 dtex, the content of the uncolored ultrafine chemical fibers is 5 to 70 mass % and the content of the colored fibers is 20 to 60 mass %, in the fiber molded body for sound absorbing/sound insulation materials.

In addition, the fiber molded body for sound absorbing/sound insulation materials of the present invention contains uncolored ultrafine chemical fibers and reclaimed fibers, the single fiber fineness of the uncolored ultrafine chemical fibers is 0.01 to 0.5 dtex, the content of the uncolored ultrafine chemical fibers is 5 to 70 mass % and the content of the reclaimed fibers is 20 to 60 mass %, in the fiber molded body for sound absorbing/sound insulation materials.

When uncolored ultrafine chemical fibers (hereinafter also simply referred to as “ultrafine chemical fibers”) are contained, the weight can be reduced without deteriorating sound absorption/sound insulation performance, and the cost can also be reduced. In addition, when colored fibers are used, since a mixed cotton state can be determined from the appearance, the uniformity of quality can be easily obtained.

If the single fiber fineness of the ultrafine chemical fibers is 0.01 dtex or more, the handling of fibers during production of a molded product is favorable, and the production cost does not become too high. If the single fiber fineness is 0.5 dtex or less, favorable sound absorption/sound insulation performance can be obtained.

From these viewpoints, the single fiber fineness of the ultrafine chemical fibers is 0.01 to 0.5 dtex, preferably 0.05 to 0.4 dtex, and more preferably 0.1 to 0.3 dtex.

If the content of the ultrafine chemical fibers in the fiber molded body for sound absorbing/sound insulation materials is 5 mass % or more, the sound absorption/sound insulation performance tends to be improved. If the content is 70 mass % or less, colored fibers and reclaimed fibers can be sufficiently used. In addition, other fibers such as thermally fused fibers can be contained, which makes it easier to obtain shape stability and lower costs.

From these viewpoints, the content of the ultrafine chemical fibers in the fiber molded body for sound absorbing/sound insulation materials is 5 to 70 mass %, preferably 10 to 60 mass %, and more preferably 20 to 50 mass %.

If the content of the colored fibers or reclaimed fibers in the fiber molded body for sound absorbing/sound insulation materials is 20 mass % or more, a mixed cotton state is easily determined from the appearance. If the content is 60 mass % or less, deterioration of sound absorption performance can be minimized.

From these viewpoints, the content of the colored fibers or reclaimed fibers in the fiber molded body for sound absorbing/sound insulation materials is 20 to 60 mass %, preferably 22 to 55 mass %, and more preferably 25 to 50 mass %.

Chemical fibers are fibers artificially produced using a chemical method, and examples thereof include synthetic fibers, semi-synthetic fibers, regenerated fibers, and inorganic fibers. Among these, synthetic fibers are preferable due to excellent strength and chemical resistance. Among the synthetic fibers, acrylic fibers and polyester fibers are preferable in order to further reduce the cost.

“Coloring” refers to, for example, dying fibers with a dye, mixing a pigment into fibers, decolorizing fibers with a bleaching agent or the like, and refers to artificially changing the color. “Uncolored” means that the color of the fiber itself is exhibited.

When reclaimed fibers are used in place of colored fibers, this contributes to the circular economy and the production cost is reduced.

The reclaimed fibers are fibers made into a cotton form from general waste such as cutting wastage of a woven knitted product obtained in a cloth producing process, used clothes or a futon using a reclaimed fiber machine. In the present invention, the material of the reclaimed fiber is not particularly limited, and natural fibers such as plant fibers and animal fibers may be used, and chemical fibers such as polyester fibers, nylon fibers, and acrylic fibers may be used. These materials may be used alone or may be used in a mixture.

In the present invention, the reclaimed fibers may be fibers obtained by reusing cotton waste, yarn waste or the like that cannot be made into a product.

The colored fibers contained in the fiber molded body for sound absorbing/sound insulation materials of the present invention are preferably reclaimed fibers.

When reclaimed fibers, which are colored fibers, are used, it is possible to check a mixed cotton state from the appearance, this further contributes to the circular economy and the production cost is reduced.

If the content of the reclaimed fibers in the fiber molded body for sound absorbing/sound insulation materials is 20 mass % or more, this can greatly contribute to the circular economy. If the content is 60 mass % or less, deterioration of sound absorption performance can be inhibited.

From these viewpoints, the content of the reclaimed fibers in the fiber molded body for sound absorbing/sound insulation materials is more preferably 22 to 55 mass % and still more preferably 25 to 50 mass %.

The sound absorbing material is generally placed in a location that is hardly visible from the outside. Since coloring fibers is costly and time-consuming, generally, fibers used for the sound absorbing material are not colored. Therefore, it can be determined that fibers are reclaimed fibers by the fact that a plurality of fibers are in the form of threads, fibers with a plurality of colors are mixed, or a plurality of types of fibers have the same color.

The colored fibers or reclaimed fibers contained in the fiber molded body for sound absorbing/sound insulation materials of the present invention are composed of chemical fibers and natural fibers, and the mass ratio between the chemical fibers and the natural fibers (chemical fibers:natural fibers) in the colored fibers or reclaimed fibers is preferably 40:60 to 95:5.

The cost can be reduced because the colored fibers or reclaimed fibers are composed of chemical fibers and natural fibers. If the proportion of the chemical fibers in the colored fibers or reclaimed fibers is 40 mass % or more, the molded product does not become too soft, and it is easy to maintain the shape. In addition, when natural fibers are contained, it becomes easy to improve the moisture absorption property. The natural fiber is preferably wool, and since wool has excellent flame retardancy and heat retention, it is suitable for use in, for example, a dash insulator of a vehicle, and an interior material.

From these viewpoints, the mass ratio between the chemical fibers and the natural fibers (chemical fibers:natural fibers) in the colored fibers or reclaimed fibers is preferably 40:60 to 95:5, more preferably 50:50 to 85:15, and still more preferably 60:40 to 75:25.

The content of the natural fibers in the fiber molded body for sound absorbing/sound insulation materials of the present invention is preferably 35 mass % or less.

When the fiber molded body for sound absorbing/sound insulation materials contains natural fibers, the moisture absorption property of the molded product is easily improved, and if the content thereof is 35 mass % or less, it is easy to maintain the shape of the molded product.

From these viewpoints, the content of the natural fibers in the fiber molded body for sound absorbing/sound insulation materials of the present invention is preferably 35 mass % or less, more preferably 25 mass % or less, and still more preferably 20 mass % or less.

The fiber molded body for sound absorbing/sound insulation materials of the present invention may further contain uncolored chemical fibers having a single fiber fineness of 5 dtex or more. When the fiber molded body for sound absorbing/sound insulation materials of the present invention contains uncolored chemical fibers having a single fiber fineness of 5 dtex or more, the content of the uncolored chemical fibers having a single fiber fineness of 5 dtex or more in the fiber molded body for sound absorbing/sound insulation materials is preferably 5 to 30 mass %.

When the fiber molded body for sound absorbing/sound insulation materials contains uncolored chemical fibers having a single fiber fineness of 5 dtex or more, the fiber molded body does not become too soft and it is easy to maintain the shape.

From this viewpoint, the single fiber fineness of the uncolored chemical fibers having a single fiber fineness of 5 dtex or more is more preferably 5.5 dtex or more, and more preferably 6 dtex or more.

In addition, if the content of the uncolored chemical fibers having a single fiber fineness of 5 dtex or more in the fiber molded body for sound absorbing/sound insulation materials is 5 mass % or more, it is easy to maintain the shape of the fiber molded body. If the content is 30 mass % or less, the deterioration of the sound absorption performance can be reduced.

From these viewpoints, the content of the uncolored chemical fibers having a single fiber fineness of 5 dtex or more in the fiber molded body for sound absorbing/sound insulation materials is preferably 5 to 30 mass %, more preferably 8 to 25 mass %, and still more preferably 10 to 20 mass %.

In addition, the cost can be reduced because chemical fibers having a single fiber fineness of 5 dtex or more are uncolored.

The fiber length of the uncolored ultrafine chemical fiber contained in the fiber molded body for sound absorbing/sound insulation materials of the present invention is preferably 12 to 60 mm.

If the fiber length of the ultrafine chemical fiber contained in the fiber molded body for sound absorbing/sound insulation materials is 12 mm or more, the obtained fiber molded body for sound absorbing/sound insulation materials tends to have high strength because the entanglement between the fibers is sufficiently applied, the air permeability of the molded product decreases because the entanglement is sufficient, and the sound absorption performance is likely to be improved.

From these viewpoints, the fiber length of the ultrafine chemical fiber is preferably 12 mm or more, more preferably 15 mm or more, and still more preferably 20 mm or more.

If the fiber length of the uncolored ultrafine chemical fiber contained in the fiber molded body for sound absorbing/sound insulation materials is 60 mm or less, the dispersibility of the fiber is favorable and the molded product is easily molded.

From this viewpoint, the fiber length of the ultrafine chemical fiber is preferably 60 mm or less, more preferably 50 mm or less, and still more preferably 40 mm or less.

The above upper limits and lower limits can be arbitrarily combined. For example, the fiber length of the ultrafine chemical fiber is preferably 12 to 60 mm, more preferably 15 to 50 mm, and still more preferably 20 to 40 mm.

The density of the fiber molded body for sound absorbing/sound insulation materials of the present invention is preferably 10 to 70 kg/m³.

If the density of the fiber molded body for sound absorbing/sound insulation materials is 10 kg/m³ or more, the sound absorption/sound insulation performance tends to be improved. If the density is 70 kg/m³ or less, it is easy to reduce the weight. From these viewpoints, the density of the fiber molded body for sound absorbing/sound insulation materials is preferably 10 to 70 kg/m³, more preferably 20 to 65 kg/m³, and still more preferably 30 to 60 kg/m³.

The material of the ultrafine chemical fibers contained in the fiber molded body for sound absorbing/sound insulation materials of the present invention is not particularly limited, but for example, synthetic fibers such as acrylic fibers, polyester fibers, and nylon fibers, and semi-synthetic fibers such as acetate and promix can be suitably used.

Among these, if the ultrafine chemical fibers are acrylic fibers, when fibers having a relatively small single fiber fineness of 0.01 to 0.5 dtex are used, the sound absorption property for sounds having frequencies of 800 to 2,000 Hz can be improved, and the production cost can be reduced.

Particularly, in order to reduce the weight, acrylic fibers and nylon fibers having a small specific gravity can be used more suitably, and in consideration of the sound absorption property and productivity of fineness fibers, acrylic fibers can be used more suitably.

When acrylic fibers are used as ultrafine chemical fibers, it is possible to easily improve the sound absorption property for sounds having frequencies of 800 to 2,000 Hz. Since this frequency range has a range overlapping a frequency range of the engine sound of a vehicle, when acrylic fibers are used as ultrafine chemical fibers, the fiber molded body for sound absorbing/sound insulation materials can be suitably used for vehicle applications.

The fiber molded body for sound absorbing/sound insulation materials of the present invention may contain thermally fused fibers; inorganic fibers such as glass fibers and mineral fibers to impart flame retardant performance; or other fibers, in addition to uncolored ultrafine chemical fibers and colored fibers or reclaimed fibers. The single fiber fineness of the other fibers is larger than 0.5 dtex.

When the fiber molded body for sound absorbing/sound insulation materials contains thermally fused fibers, the uncolored ultrafine chemical fibers are preferably non-fused fibers that do not melt at a temperature at which thermally fused fibers melt.

In one aspect of the fiber molded body for sound absorbing/sound insulation materials of the present invention, preferably, the basis weight is 1,000 to 2,500 g/m², and the sound absorption coefficient at a frequency of 1,000 Hz is 0.5 or more.

If the basis weight of the fiber molded body for sound absorbing/sound insulation materials is 1,000 g/m² or more, the sound absorption property is easily improved, and if the basis weight is 2,500 g/m² or less, the molded product does not become too heavy.

From these viewpoints, the basis weight of the fiber molded body for sound absorbing/sound insulation materials is preferably 1,000 to 2,500 g/m², more preferably 1,100 to 2,000 g/m², and still more preferably 1,200 to 1,700 g/m².

If the sound absorption coefficient at a frequency of 1,000 Hz of the fiber molded body for sound absorbing/sound insulation materials is 0.5 or more, an effect of reducing an engine sound and a transmitted sound from the dash compartment is excellent.

From this viewpoint, the sound absorption coefficient at a frequency of 1,000 Hz of the fiber molded body for sound absorbing/sound insulation materials is preferably 0.5 or more, more preferably 0.55 or more, and still more preferably 0.60 or more.

If the basis weight of the fiber molded body for sound absorbing/sound insulation materials of the present invention is 1,000 to 2,500 g/m², the sound absorption coefficient at a frequency of 800 Hz is preferably 0.4 or more.

If the sound absorption coefficient at a frequency of 800 Hz is 0.4 or more, an effect of reducing an engine sound and a transmitted sound from the dash compartment is excellent.

If the basis weight of the fiber molded body for sound absorbing/sound insulation materials of the present invention is 1,000 to 2,500 g/m², the sound absorption coefficient at a frequency of 500 Hz is preferably 0.25 or more.

If the sound absorption coefficient at a frequency of 500 Hz is 0.25 or more, an effect of reducing an engine sound and a transmitted sound from the dash compartment is excellent.

If the basis weight of the fiber molded body for sound absorbing/sound insulation materials of the present invention is 1,000 to 2,500 g/m², the thickness is preferably 10 to 40 mm.

If the thickness of the fiber molded body for sound absorbing/sound insulation materials is 10 mm or more, an effect of reducing an engine sound and a transmitted sound from the dash compartment is excellent, and if the thickness is 40 mm or less, an effect of reducing the weight is excellent.

From these viewpoints, if the basis weight is 1,000 to 2,500 g/m², the thickness of the fiber molded body for sound absorbing/sound insulation materials is preferably 10 to 40 mm, more preferably 15 to 38 mm, and still more preferably 20 to 35 mm.

In another aspect of the fiber molded body for sound absorbing/sound insulation materials of the present invention, the basis weight is 100 g/m² or more and less than 1,000 g/m², and the sound absorption coefficient at 1,000 Hz is preferably 0.35 or more.

If the basis weight of the fiber molded body for sound absorbing/sound insulation materials is 100 g/m² or more, the sound absorption property is improved, and if the basis weight is less than 1,000 g/m², the weight is easily reduced.

From these viewpoints, the basis weight of the fiber molded body for sound absorbing/sound insulation materials is preferably 100 g/m² or more and less than 1,000 g/m², more preferably 300 to 950 g/m², and still more preferably 500 to 900 g/m².

If the sound absorption coefficient at a frequency of 1,000 Hz of the fiber molded body for sound absorbing/sound insulation materials is 0.35 or more, an effect of reducing an engine sound and a transmitted sound from the dash compartment is excellent.

If the basis weight of the fiber molded body for sound absorbing/sound insulation materials of the present invention is 100 g/m² or more and less than 1,000 g/m², the sound absorption coefficient at a frequency of 800 Hz is preferably 0.25 or more.

If the sound absorption coefficient at a frequency of 800 Hz is 0.25 or more, an effect of reducing an engine sound and a transmitted sound from the dash compartment is excellent.

If the basis weight of the fiber molded body for sound absorbing/sound insulation materials of the present invention is 100 g/m² or more and less than 1,000 g/m², the sound absorption coefficient at 500 Hz is preferably 0.20 or more.

If the basis weight is 100 to 1,000 g/m², when the sound absorption coefficient at 500 Hz is 0.20 or more, it can be said that the sound absorption effect is favorable.

If the basis weight of the fiber molded body for sound absorbing/sound insulation materials of the present invention is 100 g/m² or more and less than 1,000 g/m², the thickness is preferably 5 to 30 mm.

If the thickness of the fiber molded body for sound absorbing/sound insulation materials is 5 mm or more, the sound absorption performance tends to be improved, and if the thickness is 30 mm or less, an effect of reducing the weight is excellent. From these viewpoints, if the basis weight is 100 g/m² or more and less than 1,000 g/m², the thickness of the fiber molded body for sound absorbing/sound insulation materials is preferably 5 to 30 mm, more preferably 10 to 28 mm, and still more preferably 18 to 25 mm.

Preferably, the number of crimps of the uncolored ultrafine chemical fibers contained in the fiber molded body for sound absorbing/sound insulation materials of the present invention is 8 to 14/25 mm, and the crimping ratio is 5 to 9%.

If the number of crimps is 8 to 14/25 mm, and the crimping ratio is 5 to 9%, the moldability when making fiber molded bodies is improved.

The fiber molded body for sound absorbing/sound insulation materials of the present invention can contain thermally fused fibers. When the fibers constituting the molded product are fixed with thermally fused fibers, this is preferable because even a complicated shape can be maintained.

The thermally fused fibers in this specification are fibers that melt at a temperature lower than the melting temperature of general molten fibers such as polyester. Specific examples of thermally fused fibers include low-melting-point polyesters, polyethylenes, polypropylenes, cores/sheaths of these fibers, and composite fibers such as side-by-side type fibers.

When the fiber molded body for sound absorbing/sound insulation materials of the present invention contains thermally fused fibers, the single fiber fineness of the thermally fused fibers used is preferably 1 to 5 dtex.

If the single fiber fineness of the thermally fused fibers is 1 dtex or more, it is easy to fix the fibers constituting the fiber molded body for sound absorbing/sound insulation materials. If the single fiber fineness is 5 dtex or less, the sound absorption coefficient is unlikely to decrease.

From these viewpoints, the single fiber fineness of the thermally fused fibers is preferably 1 to 5 dtex, and more preferably 1.5 to 3 dtex.

When the fiber molded body for sound absorbing/sound insulation materials of the present invention contains thermally fused fibers, the fiber length of the thermally fused fibers used is preferably 5 to 200 mm, more preferably 10 to 100 mm, and still more preferably 20 to 80 mm. If the fiber length is the lower limit value of the above range or more, the thermal fusion performance becomes sufficient. If the fiber length is the upper limit value or less, sufficient processability can be maintained.

When the fiber molded body for sound absorbing/sound insulation materials of the present invention contains thermally fused fibers, the content of the thermally fused fibers in the fiber molded body for sound absorbing/sound insulation materials is preferably 10 to 50 mass %. if the content of the thermally fused fibers is 10 mass % or more, it is easy to maintain the shape of the fiber molded body. If the content is 50 mass % or less, the ultrafine chemical fibers can be sufficiently contained, and the sound absorption/sound insulation performance can be easily improved. From these viewpoints, the content of the thermally fused fibers is preferably 10 to 50 mass %, more preferably 15 to 45 mass %, and still more preferably 20 to 40 mass %.

The fiber molded body for sound absorbing/sound insulation materials of the present invention can be obtained by molding a mixture containing uncolored ultrafine chemical fibers, colored fibers or reclaimed fibers, and as necessary, other fibers into a desired shape by a known method.

For example, the fiber molded body can be molded by a method in which a fiber mixture containing uncolored ultrafine chemical fibers, colored fibers or reclaimed fibers, and thermally fused fibers is formed into a desired shape, and heated to melt the thermally fused fibers, and the fibers contained in the fiber mixture are fixed.

Specific examples of the fiber molded body for sound absorbing/sound insulation materials include non-woven fabrics, paper, and a multi-layer structure thereof. A non-woven fabric is preferable in consideration of the processability and cost.

Since the fiber molded body for sound absorbing/sound insulation materials of the present invention has excellent sound absorption/sound insulation performance and is lightweight, it is suitably used for a vehicle body of a vehicle and the like and interior or exterior materials of houses and the like, and has an excellent effect of improving the silence property in a room.

Specifically, the sound absorption performance is improved by mixing uncolored ultrafine chemical fibers having a single fiber fineness of 0.01 to 0.5 dtex despite the fact that reclaimed fibers are contained. In particular, the fiber molded body exhibits excellent sound absorption performance for sounds having frequencies of 800 to 2,000 Hz, and for example, can be suitably used for preventing in-vehicle noise in a vehicle.

Method For Producing Uncolored Ultrafine Chemical Fibers

An example in which acrylic fibers are used as uncolored ultrafine chemical fibers will be described below.

The acrylic fibers in this specification contain an acrylic polymer obtained by copolymerizing acrylonitrile and unsaturated monomers that can be polymerized therewith. As the unsaturated monomers, for example, acrylic acid, methacrylic acid, or alkyl esters thereof, vinyl acetate, acrylamide, vinyl chloride, vinylidene chloride, and depending on the purpose, ionic unsaturated monomers such as sodium vinylbenzene sulfonate, sodium methallylsulfonate, sodium allylsulfonate, sodium acrylamide methyl propane sulfonate, and sodium parasulfophenyl metallyl ether can be used.

The content of the acrylonitrile unit among all units in the acrylic polymer is preferably 80 mass % or more, and more preferably 85 mass % or more. In addition, the upper limit is preferably 99 mass % or less.

The unsaturated monomers may be used alone or two or more thereof may be used in combination.

The acrylic fibers in this specification can contain a substance such as titanium oxide and an antibacterial agent in a range in which the substance does not adversely affect an acrylic fiber producing process, and an oil may be adhered to the fiber surface.

In addition, the acrylic polymers constituting the uncolored ultrafine chemical fibers may be used alone or two or more thereof may be used in combination. For example, a mixture containing two or more types of acrylic polymers having different acrylonitrile contents may be used.

As a method for polymerizing acrylic polymers, for example, suspension polymerization or solution polymerization can be selected, but the method is not particularly limited.

The molecular weight of the acrylic polymer may be a molecular weight in any range in which it is generally used when acrylic fibers are produced, and is not particularly limited. However, when a 0.5 weight % dimethylformamide solution is used, it is preferable to perform adjustment so that the reduced viscosity at 25° C. is in a range of 1.5 to 3.0.

As a method for producing an acrylic fiber (xa) using an acrylic polymer as a raw material, known methods such as a wet fiber spinning method, a dry and wet fiber spinning method, and a dry fiber spinning method can be used. A wet fiber spinning method is preferable in consideration of the productivity and cost.

In the wet fiber spinning method, first, a fiber spinning stock solution containing an acrylic polymer is discharged from a plurality of discharge holes into a coagulation bath to obtain a coagulated yarn.

The fiber spinning stock solution is prepared by dissolving an acrylic polymer in a solvent so that the concentration is 15 mass % to 28 mass %. When the concentration of the acrylic polymer is 15 mass % or more, the difference between the shape of the nozzle hole and the shape of the fiber cross section does not become large during coagulation, and it is easy to obtain a desired shape of the cross section. When the concentration is 28 mass % or less, the stability of the fiber spinning stock solution over time is improved, and the fiber spinning stability is improved.

As the solvent, for example, in addition to organic solvents such as dimethylformamide, dimethylacetamide, and dimethyl sulfoxide, nitric acid, a rodanate aqueous solution, and a zinc chloride aqueous solution can be used, but when the shape of the cross section is controlled so that it is closer to the shape of the nozzle hole, an organic solvent is beneficially used.

In order to maintain a favorable fiber spinning state, spinning and withdrawing may be performed so that the fiber spinning draft defined by the value obtained by dividing a take-up speed of the coagulated yarn by the discharge line speed of the fiber spinning stock solution is in a range of 0.7 to 3.0. If the fiber spinning draft is 0.7 or more, the difference between the shape of the nozzle hole and the shape of the fiber cross section is small during coagulation, it is easy to obtain a desired shape of the cross section, and the cross section unevenness is reduced. If the fiber spinning draft is 3.0 or less, there is little yarn breakage in the coagulation bath liquid, and it is easy to obtain the fiber itself.

The obtained coagulated yarn is stretched, washed, and dried according to known methods and conditions, and the obtained fibers can be cut to a predetermined length according to applications and used as raw cotton.

### EXAMPLES

Hereinafter, the present invention will be described in more detail with reference to examples.

The measurement of respective items in examples was based on the following method.

<Method of Measuring Single Fiber Fineness>

Measurement was performed using auto vibro-type fineness measuring instrument (Denior Computer DC-11 commercially available from Search Control Electric Co., Ltd.) under conditions of a temperature of 25° C. and a humidity of 65%. The measurement was performed 25 times, and the average value was used.

<Method of Measuring Number of Crimps and Crimping Ratio>

Measurement was performed according to JIS L 1015 (2010) 8.12.

<Method of Measuring Vertically Incident Sound Absorption Coefficient and Transmission Loss>

For the fiber molded body, according to JIS A 1405-2 and ASTM E2611, a sound absorption coefficient (vertically incident sound absorption coefficient) and a transmission loss (vertically incident transmission loss) were measured in a predetermined frequency range. As the measurement device, a model number WinZac (commercially available from Nihon Onkyo Engineering Co., Ltd.) was used.

### Example 1

A copolymer composed of 93 mass % of acrylonitrile unit and 7 mass % of vinyl acetate unit was obtained by aqueous suspension polymerization. The reduced viscosity of this copolymer in the 0.5 mass % dimethylformamide solution at 25° C. was 2.0. This copolymer was dissolved in dimethylacetamide to obtain a fiber spinning stock solution having a copolymer concentration of 24 mass %. The fiber spinning stock solution was spun into a 50% dimethylacetamide aqueous solution at 40° C. from the discharge hole of the fiber spinning nozzle. In addition, the sample was stretched to 5 times its length with hot water at 95° C. and washed, an oil was applied thereto, and then it was dried with a drying roller, and mechanical crimping was additionally performed to obtain uncolored ultrafine chemical fibers having a number of crimps of 10/25 mm, a crimping ratio of 7%, and a single fiber fineness of 0.1 dtex.

Uncolored ultrafine chemical fibers (non-thermally fused fibers) cut to a fiber length of 40 mm, (uncolored) thermally fused polyester fibers having a single fiber fineness of 4.4 dtex and a fiber length of 50 mm, (uncolored) polyester fibers having a single fiber fineness of 6 dtex and a fiber length of 64 mm and colored fibers which are reclaimed fibers composed of 60 mass % of chemical fibers and 40 mass % of natural fibers were mixed at a ratio of 30 mass %, 30 mass %, 15 mass %, and 25 mass % to prepare a non-woven fabric with a carding machine. Then, heating was performed to obtain a fiber molded body.

The basis weight of the obtained fiber molded body was 1,200 g/m², and the thickness was 30 mm

Table 2 shows the measurement results of the sound absorption coefficient, and Table 3 shows the measurement results of the transmission loss.

### Examples 2 to 6 and Comparative Examples 1 and 2

Fiber molded bodies were obtained in the same manner as in Example 1 except that the content of the uncolored ultrafine chemical fibers, the content of the colored fibers, the density of the fiber molded bodies, the basis weight and the thickness were changed as shown in Table 1.

Table 2 shows the measurement results of the sound absorption coefficient, and Table 3 shows the measurement results of the transmission loss.

TABLE 1

| | | | | | | | | Comparative | |
|---|---|---|---|---|---|---|---|---|---|
| | | Example | | | | | | Example | |
| | | 1 | 2 | 3 | 4 | 5 | 6 | 1 | 2 |
| Mixing | Ultrafine | 30 | 10 | 10 | 10 | 30 | 10 | 0 | 0 |
| ratio | chemical | | | | | | | | |
| (mass %) | fiber 0.1 | | | | | | | | |
| | dtex | | | | | | | | |
| | Colored | 25 | 45 | 45 | 45 | 25 | 45 | 55 | 55 |
| | fiber | | | | | | | | |
| | (reclaimed | | | | | | | | |
| | fiber) | | | | | | | | |
| | Thermally- | 30 | 30 | 30 | 30 | 30 | 30 | 30 | 30 |
| | fused | | | | | | | | |
| | polyester | | | | | | | | |
| | fiber 4.4 | | | | | | | | |
| | dtex | | | | | | | | |
| | Polyester | 15 | 15 | 15 | 15 | 15 | 15 | 15 | 15 |
| | fiber 6 | | | | | | | | |
| | dtex | | | | | | | | |

| | | | | | | | | |
|---|---|---|---|---|---|---|---|---|
| Content of natural | 10 | 18 | 18 | 18 | 10 | 18 | 22 | 22 |
| fiber in fiber molded | | | | | | | | |
| body (mass %) | | | | | | | | |
| Density (kg/m³) | 40 | 47 | 33 | 30 | 23 | 23 | 47 | 27 |
| Basis weight (g/m²) | 1200 | 1400 | 1000 | 900 | 700 | 700 | 1400 | 800 |
| Thickness (mm) | 30 | 25 | 25 | 20 | 15 | 20 | 25 | 20 |

TABLE 2

| Frequency | Sound absorption coefficient | | | | | | | | | | | |
|---|---|---|---|---|---|---|---|---|---|---|---|---|
| (Hz) | 315 | 400 | 500 | 630 | 800 | 1000 | 1250 | 1600 | 2000 | 2500 | 3150 | 4000 |
| Example 1 | 0.04 | 0.17 | 0.28 | 0.38 | 0.54 | 0.69 | 0.82 | 0.92 | 0.96 | 0.97 | 0.96 | 0.94 |
| Example 2 | 0.07 | 0.16 | 0.25 | 0.37 | 0.48 | 0.61 | 0.75 | 0.87 | 0.94 | 0.99 | 1.00 | 0.97 |
| Example 3 | 0.04 | 0.14 | 0.23 | 0.31 | 0.40 | 0.53 | 0.68 | 0.81 | 0.90 | 0.97 | 0.99 | 0.98 |
| Example 4 | 0.05 | 0.14 | 0.20 | 0.25 | 0.32 | 0.42 | 0.53 | 0.65 | 0.77 | 0.88 | 0.95 | 0.98 |
| Example 5 | 0.01 | 0.09 | 0.15 | 0.21 | 0.27 | 0.40 | 0.52 | 0.67 | 0.79 | 0.89 | 0.96 | 0.99 |
| Example 6 | 0.05 | 0.13 | 0.19 | 0.23 | 0.29 | 0.37 | 0.46 | 0.57 | 0.68 | 0.80 | 0.89 | 0.94 |
| Comparative | 0.06 | 0.16 | 0.23 | 0.29 | 0.35 | 0.47 | 0.57 | 0.69 | 0.79 | 0.88 | 0.94 | 0.95 |
| Example 1 | | | | | | | | | | | | |
| Comparative | 0.06 | 0.13 | 0.19 | 0.23 | 0.24 | 0.30 | 0.35 | 0.44 | 0.50 | 0.59 | 0.69 | 0.76 |
| Example 2 | | | | | | | | | | | | |

TABLE 3

| Frequency | Vertically incident transmission loss (dB) | | | | | | | | | | | |
|---|---|---|---|---|---|---|---|---|---|---|---|---|
| (Hz) | 315 | 400 | 500 | 630 | 800 | 1000 | 1250 | 1600 | 2000 | 2500 | 3150 | 4000 |
| Example 1 | 3.02 | 4.40 | 5.03 | 5.46 | 5.66 | 6.04 | 6.46 | 6.94 | 7.46 | 8.10 | 8.96 | 9.97 |
| Example 2 | 3.63 | 3.39 | 4.02 | 4.57 | 4.93 | 5.14 | 5.50 | 5.93 | 6.37 | 6.92 | 7.64 | 8.46 |
| Example 3 | 2.06 | 2.75 | 3.26 | 3.57 | 3.78 | 4.03 | 4.35 | 4.69 | 5.04 | 5.46 | 6.03 | 6.68 |
| Example 4 | 1.85 | 2.27 | 2.76 | 3.02 | 3.22 | 3.41 | 3.67 | 3.96 | 4.25 | 4.60 | 5.06 | 5.58 |
| Example 5 | 2.30 | 3.15 | 3.81 | 4.17 | 4.33 | 4.64 | 4.99 | 5.31 | 5.64 | 6.01 | 6.52 | 7.12 |
| Example 6 | 1.49 | 1.97 | 2.19 | 2.32 | 2.49 | 2.70 | 2.89 | 3.13 | 3.36 | 3.63 | 3.99 | 4.39 |
| Comparative | 2.31 | 2.34 | 2.56 | 2.90 | 3.11 | 3.33 | 3.51 | 3.78 | 4.04 | 4.34 | 4.74 | 5.17 |
| Example 1 | | | | | | | | | | | | |
| Comparative | 1.09 | 1.31 | 1.44 | 1.54 | 1.66 | 1.79 | 1.93 | 2.08 | 2.22 | 2.40 | 2.64 | 2.90 |
| Example 2 | | | | | | | | | | | | |

As shown in the results of Tables 1 and 2, the fiber molded bodies of Examples 1 to 6 exhibited excellent sound absorbing characteristics.

Comparing Example 2 and Comparative Example 1, it can be understood that the sound absorption performance can be improved by mixing ultrafine chemical fibers.

In addition, as shown in the results of Tables 1 and 3, the fiber molded bodies of Examples 1 to 6 exhibited excellent sound insulation characteristics.

### INDUSTRIAL APPLICABILITY

The fiber molded body for sound absorbing/sound insulation materials of the present invention can be beneficially applied to materials for which lightweight and silence are required, for example, vehicle interior or exterior materials, and sound absorbing/sound insulation materials of house building materials.

1. A fiber molded body for sound absorbing/sound insulation materials comprising uncolored ultrafine chemical fibers and colored fibers,
wherein the single fiber fineness of the ultrafine chemical fibers is 0.01 to 0.5 dtex, and
wherein the content of the ultrafine chemical fibers in the fiber molded body for sound absorbing/sound insulation materials is 5 to 70 mass %, and the content of the colored fibers in the fiber molded body for sound absorbing/sound insulation materials is 20 to 60 mass %, or
a fiber molded body for sound absorbing/sound insulation materials comprising uncolored ultrafine chemical fibers and reclaimed fibers,
wherein the single fiber fineness of the ultrafine chemical fibers is 0.01 to 0.5 dtex, and
wherein the content of the ultrafine chemical fibers in the fiber molded body for sound absorbing/sound insulation materials is 5 to 70 mass %, and the content of the reclaimed fibers in the fiber molded body for sound absorbing/sound insulation materials is 20 to 60 mass %.

2. The fiber molded body for sound absorbing/sound insulation materials according to claim 1,
wherein the colored fibers are reclaimed fibers.

3. The fiber molded body for sound absorbing/sound insulation materials according to claim 1,
wherein the colored fibers and the reclaimed fibers are composed of chemical fibers and natural fibers, and the ratio between the chemical fibers and the natural fibers (chemical fibers (mass %):natural fibers (mass %)) is 40:60 to 95:5.

4. The fiber molded body for sound absorbing/sound insulation materials according to claim 1,
wherein the content of the natural fibers in the fiber molded body for sound absorbing/sound insulation materials is 35 mass % or less.

5. The fiber molded body for sound absorbing/sound insulation materials according to claim 1, further containing uncolored chemical fibers having a single fiber fineness of 5 dtex or more,
wherein the content of the uncolored chemical fibers having a single fiber fineness of 5 dtex or more in the fiber molded body for sound absorbing/sound insulation materials is 5 to 30 mass %.

6. The fiber molded body for sound absorbing/sound insulation materials according to claim 1,
wherein the fiber length of the ultrafine chemical fibers is 12 to 60 mm.

7. The fiber molded body for sound absorbing/sound insulation materials according to claim 1,
wherein the density is 10 to 70 kg/m³.

8. The fiber molded body for sound absorbing/sound insulation materials according to claim 1,
wherein the basis weight is 1,000 to 2,500 g/m², and the sound absorption coefficient at a frequency of 1,000 Hz is 0.5 or more.

9. The fiber molded body for sound absorbing/sound insulation materials according to claim 8,
wherein the sound absorption coefficient at a frequency of 800 Hz is 0.4 or more.

10. The fiber molded body for sound absorbing/sound insulation materials according to claim 8,
wherein the sound absorption coefficient at a frequency of 500 Hz is 0.25 or more.

11. The fiber molded body for sound absorbing/sound insulation materials according to claim 8,
wherein the thickness is 10 to 40 mm.

12. The fiber molded body for sound absorbing/sound insulation materials according to claim 1,
wherein the basis weight is 100 g/m² or more and less than 1,000 g/m², and the sound absorption coefficient at 1,000 Hz is 0.35 or more.

13. The fiber molded body for sound absorbing/sound insulation materials according to claim 12,
wherein the sound absorption coefficient at 800 Hz is 0.25 or more.

14. The fiber molded body for sound absorbing/sound insulation materials according to claim 12,
wherein the sound absorption coefficient at 500 Hz is 0.20 or more.

15. The fiber molded body for sound absorbing/sound insulation materials according to claim 12,
wherein the thickness is 5 to 30 mm.
